(19) United States
(12) Patent Application Publication
(10) Pub. No.: US 2017/0007980 A1
(43) Pub. Date: Jan. 12, 2017

(54) PROCESS FOR THE PRODUCTION OF HIGH-QUALITY ACTIVATED CARBONS AS WELL AS ACTIVATED CARBONS PRODUCED ACCORDING TO THE PROCESS

(71) Applicant: AVA-CO2 Schweiz AG, Zug (CH)

(72) Inventors: Jan VYSKOCIL, Zug (CH); Olga SAHIN, Karlsruhe (DE); Mei Yun LAI, Puchorg (MY); Andrea KRUSE, Bruchsal (DE)

(73) Assignee: AVA-CO2 Schweiz AG, Zug (CH)

(21) Appl. No.: 15/272,779

(22) Filed: Sep. 22, 2016

Related U.S. Application Data
(62) Division of application No. 14/820,909, filed on Aug. 7, 2015.

(30) Foreign Application Priority Data
Aug. 8, 2014 (DE) 10 2014 111 329.2

(51) Int. Cl. B01J 20/20; C01B 31/08; C01B 31/12; B01J 20/28

(52) U.S. Cl. CPC B01J 20/20; B01J 20/28064; B01J 20/28066; C01B 31/081; C01B 31/12

(57) ABSTRACT

A process for the production of high-quality activated carbons from carbonized, self-regenerating, carbon-containing biomasses selects the carbonized biomasses from HTC carbon from fruit stones and HTC carbon from nut shells. The carbonized biomasses together with potassium hydroxide, sodium hydroxide or a mixture of both hydroxides as activator are subjected to a heat treatment at temperatures at which the activator exists in the form of a melt. The activator and the carbonized biomasses are present in a weight ratio of 0.5:1 to 6:1 at the beginning of the heat treatment.

### CROSS REFERENCE TO RELATED APPLICATIONS

This application is a divisional of and Applicant claims priority under 35 U.S.C. §§120 and 121 of U.S. application Ser. No. 14/820,909 filed on Aug. 7, 2015, which claims priority under 35 U.S.C. §119 from German Application No. 10 2014 111 329.2, filed Aug. 8, 2014, the disclosures of which are incorporated by reference. A certified copy of priority German Patent Application No. 10 2014 111 329.2 is contained in parent U.S. application Ser. No. 14/820,909.

### BACKGROUND OF THE INVENTION

1. Field of the Invention

The present invention relates to a process for the production at high-quality activated carbons from carbonized, self-regenerating, carbon-containing biomasses as well as to activated carbons produced according to the process.

2. Description of the Related Art

Activated carbon is a material based on natural raw substances, which because of its porous structure and the resulting extremely large specific surface, which is determined according to the Brunauer-Enunett-Teller (BET) method, is suitable for binding chemical compounds and molecules. Because of the high adsorptive property, activated carbon is used in the purification of exhaust air, drinking water and wastewater as well as in food products technology, pharmacy and chemistry.

A large number of carbon-containing raw substances, such as peat, brown coal and bituminous coal, are suitable for the production of activated carbons. Further input materials are self-regenerating biomasses of plant material, such as wood, grains, nut shells and fruit stones. The self-regenerating biomasses of plant material represent a considerable, renewable carbon potential and therefore rank among the environmentally friendly raw substances.

Processes for the production of activated carbon from biomasses are already known from the pertinent literature, such as the research report of the European Commission entitled the Manufacture of Activated Carbon on the Basis of Lignite and Waste Products (ISBN 92-828-5442-6). Thus activated carbons with a specific surface of up to 1,300 m²/g can be obtained from fruit stones and nut shells by pyrolytic carbonization of the biomasses and subsequent gas activation. Disadvantages, however, are the extremely unfavorable CO₂ balance as well as the release of methane in this process and the associated high environmental pollution.

In contrast to this process, it is possible with the process of the hydrothermal carbonization to make carbonized biomasses, i.e. HTC carbons, in the production of which no methane and only the least amounts of CO₂ are released, available for a subsequent activation. The hydrothermal carbonization represents a kind of “aqueous carbonization”, in which the carbon is separated from the biomass under pressure and heat.

In the Journal of Environmental Management 109 (2012), pages 61-69, Regmi et al. describe the production of an activated carbon from switchgrass, wherein the carbonized biomass is activated with an aqueous solution of potassium hydroxide at a temperature of approximately 30° C. Under these conditions, however, it has proved disadvantageous that the activation reaction leads to an increase of the specific surface only by a factor of approximately 2.4, and an activated carbon that has a very small specific surface of 5.01 m²/g is obtained.

Activated carbons with larger specific surfaces can be obtained by treatment of alkali metal hydroxides at higher temperatures. Such activation processes are known from DE 600 24 518 T2, DE 10 2010 002 706 A1 and DE 10 2011 013 314 A1. An increase of the surface is achieved in DE 600 24 518 T2 and in DE 10 2011 013 314 A1 by the conversion of specially synthesized polymers, which were obtained from petroleum-based, aromatic precursors such as phenol, melamine, furan or phthalate in a reaction, preceding the activation, with compounds, some of which are toxic, such as formaldehyde. In DE 10 2010 002 706 A1, an activation of pyrolysis coke in the presence of a polyalkylene glycol is described. In this case, an unfavorable CO₂ balance and additionally the requirement of the admixing of an organic additive are again disadvantageous.

### SUMMARY OF THE INVENTION

Starting from this background, the task underlying the present invention is to provide a process for the production of activated carbons from self-regenerating, carbon-containing biomasses that overcomes the disadvantages of the prior art and that yields a high-quality activated carbon with a large specific surface. This task is accomplished by a process for the production of high-quality activated carbons from carbonized, self-regenerating, carbon-containing biomasses, wherein the carbonized biomasses are selected from HTC carbon from fruit stones and HTC carbon from nut shells. The carbonized biomasses together with potassium hydroxide, sodium hydroxide or a mixture of both hydroxides as activator are subjected to a heat treatment at temperatures at which the activator exists in the form of a melt. The activator and the carbonized biomasses are present in a weight ratio of 0.5:1 to 6:1 at the beginning of the heat treatment. Further advantageous configurations of the process may be inferred from the discussion below.

It has been found that carbonized, self-regenerating carbon-containing biomasses, selected from HTC carbon from fruit stones and HTC carbon from nut shells, yield high-quality activated carbons with a large specific surface when they are subjected together with potassium hydroxide, sodium hydroxide or a mixture of both hydroxides as activator to a heat treatment at temperatures at which the activator exists in the form of a melt.

Potassium hydroxide melts at 360° C., the monohydrate of potassium hydroxide with a water content of up to 25 wt % already melts at 143° C. The melting point of sodium hydroxide lies at 323° C. The temperature of the heat treatment is adjusted in such a way that the activator exists in the form of a clear, liquid melt. The melt ensures a very good contact between activator and the carbonized biomass during the heat treatment. The contact with the activator during the heat treatment.

The contact with the activator during the heat treatment leads to the activation of the carbonized biomasses. High-quality activated carbons with a very large specific surface can be obtained with the process according to the invention.

The carbonized biomasses from fruit stones or from nut shells for the production of the activated carbon are obtained from a hydrothermal carbonization process. In this process, biomass is first converted under pressure and elevated temperature, especially also under supply of steam, to HTC carbon in a mixture referred to as slurry. This slurry containing the HTC carbon at the end of the process is freed from the process water, worked up further and dried. The dried carbonized biomasses are finally used as starting material for the production of activated carbons, and they yield high-quality activated carbons.

At the beginning of the heat treatment, the activator and the carbonized biomasses are present in a weight ratio of 0.5:1 to 6:1. If the proportion of activator, at 30% and lower relative to the total weight of carbonized biomass and activator, is too low, no satisfactory activation is achieved. The upper limit of the proportion of activator is determined by the increase of the dilution factor of the carbonized biomasses, a resulting relatively smaller conversion to activated carbon per cycle and ultimately by economic considerations.

In principle, the manner of the production of a mixture of carbonized biomasses and activator is uncritical. Preferably the carbonized biomasses are mixed with the activator, wherein the activator in the form of granular powder or flakes is comingled with the carbonized biomasses, which exist in granular or powdered form. The obtained mixture is then heat-treated. A further preferred procedure for the mixing of carbonized biomasses with activator consists in first introducing the activator, melting it and adding the carbonized biomasses to the melt.

According to an advantageous configuration of the process, the weight ratio of activator to carbonized biomasses lies between 0.5:1 and 4:1. A particularly preferred weight ratio lies between 1.5:1 and 2.5:1.

According to a further advantageous configuration of the process, the heat treatment is carried out at temperatures between 350° C. and 900° C. The potassium hydroxide, sodium hydroxide or a mixture of both hydroxides functioning as activator is selected in such a way that the activator forms a clear liquid melt at the temperatures selected for the heat treatment. The specific surface of the activated carbon obtained after the heat treatment in the presence of the activator is larger the higher the temperature is selected during the heat treatment. Below 350° C., an increase of the specific surface is certainly still also achieved. It takes place, however, in a much smaller extent.

In addition, the yield of activated carbon during the heat treatment decreases with increasing temperature of the heat treatment as a consequence of the loss of mass of oxygen and carbon. In a temperature range between 410° C. and 710° C., the ratio between the increase of the specific surface and the yield of activated carbon is very balanced. Therefore a temperature range between 410° C. and 710° C. is particularly preferred. Especially preferably, the heat treatment is carried out at temperatures between 570° C. and 630° C.

During the heat treatment, the temperature may be kept constant. It is also possible, however, to carry out the heat treatment at rising or falling temperatures.

According to a further advantageous configuration of the invention, the heat treatment is carried out for between 0.5 and 4 hours, preferably for between 1.5 and 3 hours, particularly preferably for between 1.5 and 2.5 hours. At times shorter than one half hour, the increase of the surface is not significant. A treatment of longer than 4 hours is not practical, for economic reasons.

According to a further advantageous configuration of the invention, the heat treatment is carried out in a nitrogen atmosphere. For this purpose the mixture of carbonized biomasses and activator may be introduced into a reaction vessel and this blanketed with nitrogen at the beginning of the heat treatment. Because of the nitrogen atmosphere, the consumption of activator during the heat treatment is reduced. Besides nitrogen, it is also possible to use other inert gases such as, for example, the noble gases helium, neon, argon, krypton, xenon and radon, which reduce or prevent the oxidation of the activator. During the heat treatment, preferably nitrogen is passed at a low rate between 10 L/hour and 40 L/hour, particularly preferably at a flow rate between 10 L/hour and 25 L/hour over the mixture of carbonized biomasses and activator. In this way, a uniform supply with nitrogen is assured.

According to a further advantageous configuration of the process, the heat treatment is followed by at least one rinsing step with deionized water and one drying step. For this purpose, the obtained activated carbon can first be rinsed with deionized water through a filter and then dried in an oven at temperatures between 80 and 150° C. Because of the rinsing with water, the basic activator is removed from the obtained activated carbon.

It is possible to undertake an additional washing step with an aqueous solution of 0.5 M hydrochloric acid. The additional washing step accelerates the neutralization of the obtained activated carbon. After an additional washing step with hydrochloric acid, a further rinse of the activated carbon with deionized water may be performed, until chloride ions are no longer detectable with a suitable indicator solution, especially 0.1 M silver nitrate.

According to a further advantageous configuration of the process, the carbonized biomasses are selected from cherry stone HTC carbon, peach stone HTC carbon and plum stone HTC carbon. The carbonized biomasses may also be selected from mixtures of different fruit stones or different nut shells or from mixtures that were produced from fruit stones and nut shells, respectively also in mixture with further self-regenerating, carbon-containing biomasses. In particular, fruit stones such as cherry stones, peach stones or plum stones are produced in large quantities as wastes in the production of food products and beverages. In this way, the starting substances for a hydrothermal carbonization and subsequent activation can be procured easily and inexpensively.

According to a further advantageous configuration of the invention, the HTC carbons used for the production of the active carbons have a specific surface smaller than 50 m²/g, preferably smaller than 30 m²/g, particularly preferably between 15 and 25 m²/g. Such HTC carbons can be obtained from biomasses in a hydrothermal carbonization process by carbonizing the biomass with water and under pressure for several hours at temperatures between 150 and 400° C., for example for one hour at 160° C. at first and then for 5 hours at 220° C. In particular, an HTC carbon comprising cherry stones with a specific surface of approximately 20 m²/g may be used.

A further subject matter are the high-quality activated carbons produced by the method according to the invention. The obtained high-quality activated carbons are characterized in that they have a large specific surface of greater than 700 m²/g, preferably greater than 1,000 m²/g, particularly preferably greater than 2,000 m²/g and especially greater than 2,500 m²/g.

According to an advantageous configuration of the activated carbons, the activated carbons have a pronounced micropore structure. A pronounced micropore structure means than more than 60% of the pores of the activated carbon are micropores, which mainly have a diameter between 0.7 and 2 nm. Hereby the activated carbons have a large number of pores and thus a large effective surface for adsorption of substances.

### DETAILED DESCRIPTION OF PREFERRED EMBODIMENTS

Further advantages and advantageous configurations may be inferred from the examples hereinafter and the claims. The examples serve for explanation of the invention and are not intended to limit it in any way.

### EXAMPLES

### Example 1

HTC carbon from cherry stones was introduced together with pure potassium hydroxide in a weight ratio of 4:1 potassium hydroxide to HTC carbon into an activation reactor and homogenized. Both the HTC carbon and the potassium hydroxide had been previously ground in a mill. The particle size of the HTC carbon was approximately 1 mm on the average. The mixture was heat-treated at 600° C. in a furnace for 2 hours. The activation conditions were selected in such a way that the potassium hydroxide was completely melted within the shortest time, so that the heat treatment took place in the presence of the melt for approximately 2 hours. After the cooling, the obtained activated carbon was rinsed with deionized water and dried for several hours in an oven at 105° C. The yield of activated carbon was approximately 20%, starting from the HTC carbon.

The activated carbon was investigated with respect to its physical properties and its adsorption capacity. The specific surface, the bulk density and the ash content were determined. In addition, the adsorption capacities for heavy metals, phenol and chloroform as well as the iodine number were determined. The following values were obtained:

| | | |
|---|---|---|
| specific (BET) surface | 2,910 | m²/g |
| bulk density | 0.16 | g/mL |
| ash content | 5 | wt % |
| maximum chloroform load | 0.97 | g/g |
| maximum Cu²⁺ load | 47.8 | mg/g |
| maximum phenol load | 50.1 | mg/g |
| iodine number | 1,016 | mg/g |

The obtained activated carbon has not only a very large specific surface of 2,910 m²/g with a value of 0.97 g/g for the maximum chloroform load, but also a very large capacity for adsorption of chloroform. Comparison measurements undertaken on a commercial activated carbon, which was produced by means of pyrolytic carbonization of the biomasses and subsequent gas activation, yielded only a specific (BET) surface of 1,100 m₂/g and a maximum chloroform load of 0.43 g/g. The capacity for the adsorption of copper, with a maximum load of 47.8 mg/g, was also higher in the comparison with the 12.1 mg/g for the commercial activated carbon.

In addition, the porosity of the obtained activated carbon was determined. For this determination, it was found that approximately two thirds of the pore volume consists of micropores, which essentially have a diameter between 0.7 and 2 nm. With a proportion of more than 60%, the obtained activated carbon has a pronounced micropore structure. Thin structure is very advantageous, because the micropores are available for the adsorption of a large number of molecules and substances.

### Example 2

The process was carried out as described under Example 1, except for the temperature of the heat treatment, which was 450° C. The yield was approximately 40%. For the obtained activated carbon, the following values were determined:

| | | |
|---|---|---|
| specific (BET) surface | 1,140 | m²/g |
| maximum chloroform load | 0.48 | g/g |
| maximum Cu²⁺ load | 19 | mg/g |
| maximum phenol load | 52.6 | mg/g |

### Example 3

The process was carried out as described under Example 1, except for the temperature of the heat treatment, which was 500° C. For the obtained activated carbon, the following values were determined:

| | | |
|---|---|---|
| specific (BET) surface | 1,290 | m²/g |
| maximum chloroform load | 0.56 | g/g |

### Example 4

The process was carried out as described under Example 1. Instead of HTC carbon from cherry stones, HTC carbon from hazelnut shells was used. The yield was approximately 12%. For the obtained activated carbon, the following values were determined:

| | | |
|---|---|---|
| specific (BET) surface | 1,998 | m²/g |
| maximum chloroform load | 0.90 | g/g |

### Example 5

The process was carried out as described under Example 1. Instead of HTC carbon from cherry stones, HTC carbon from coconut shells was used. The yield was approximately 30%. The specific (BET) surface reached 2,579 m²/g.

### Comparison Example

HTC carbon from cherry stones was activated in an aqueous solution of 0.5 M, 1 M or 2 M potassium hydroxide at 30° C. Then the potassium hydroxide solution was filtered off. The reaction product was washed with deionized water and dried in an oven at 105° C. for several hours. In a determination of the specific surface according to the BET method, the obtained reaction produce did not exhibit any significant increase of the specific surface.

### Example for HTC Carbon from Cherry Stones

Cherry stones with a water content of approximately 60% relative to the dry substance were used for the production of the HTC carbon. The Table 1 shows the composition of the cherry stones:

TABLE 1
Composition of the cherry stones

| | Proportion by mass, relative to dry substance (mass %) | | | | | | | |
|---|---|---|---|---|---|---|---|---|
| Starting | | Hemicellulose | | | | | | |
| substance | Lignin | and cellulose* | Ash | C | H | N | S | O |
| Cherry | 19.67 | 79.93 | 0.4 | 54.5 | 6.9 | 1 | 0.2 | 37 |
| stones | | | | | | | | |

*Hemicellulose and cellulose together constitute 79.93%; only lignin and ash (inorganic content) were determined

The cherry stones were subjected to a hydrothermal carbonization with water and under pressure for one hour at 160° C. and then for 5 hours at 220° C. The yield after the hydrothermal carbonization was approximately 80%. An HTC carbon with a specific surface of approximately 20 m²/g was obtained, and its calorific value of approximately 25 MJ/kg is in the range of the fossil lignite.

The determination of the properties of the activated carbons was carried out according to the methods presented hereinafter.

### Determination of the Specific Surface According to the BET Method:

The specific surface was determined via gas adsorption according to the BET method. For this purpose a multi-point BET instrument for recording the adsorption-desorption isotherms by means of nitrogen was used.

### Measurement of the Chloroform Adsorption:

The determination of the capacity for the chloroform adsorption was carried out by means of gas flow through a glass cylinder that contained 0.3 g of the obtained activated carbon. A chloroform-enriched nitrogen, which was passed with a flow rate of 25 L/hour through the glass cylinder, was used as the flow medium. The change in the mass of the activated carbon was observed and the maximum chloroform load was determined by means of a balance.

### Measurement of the Heavy Metal and Phenol Adsorption:

The determination of the maximum loading capacity was carried out respectively by means of aqueous solutions of copper sulfate and phenol in a concentration of 100 mg/L heavy metal sulfate or phenol. The obtained activated carbon was shaken for 24 hours in concentrations between 0.5 and 5 g/L in the aqueous copper sulfate or phenol solution in an overhead shaker at room temperature. Then the loading capacity was determined by optical emission spectrometry with inductively coupled plasma (ICP-OES).

### Determination of the Porosity:

The characterization of the pore distribution was carried out by the variation profile of the isothermal nitrogen sorption at 77 K in the relative pressure range p/p₀ between 0.0001 and 1. The absolute pore volume and, on the basis of the DR model (Dubinin Radushkevich), the total pore volume of pores with a diameter smaller than 2 mm were determined from the measured data. Then the isotherms of the CO₂ sorption at 273 K in the relative pressure range p/p₀ from 0.01 to 0.03 were determined. The measured data from the isothermal CO₂ sorption were also evaluated on the basis of the DR model and yielded the pore volume proportion of pores with a diameter smaller than 0.7 nm.

All features of the invention can be essential to the invention both individually and also in any combination with one another.

Accordingly, while only a few embodiments of the present invention have been shown and described, it is obvious that many changes and modifications may be made thereunto without departing from the spirit and scope of the invention.

What is claimed is:

1. An activated carbon produced by a process for producing activated carbons from carbonized, self-generating carbon-containing biomasses, the process comprising:
(a) selecting the biomasses from hydrothermal carbonized (HTC) carbon from fruit stores or hydrothermal carbonized (HTC) carbon from nut shells; and
(b) subjecting the biomasses together with potassium hydroxide, sodium hydroxide, or a mixture of potassium hydroxide and sodium hydroxide as activator to a heat treatment at temperatures where the activator exists in a form of a melt;
wherein the activator and the biomasses are present in a weight ratio of 0.5:1 to 6:1 at commencement of the heat treatment according to claim 1.

2. The activated carbon according to claim 1, wherein the activated carbon has a specific surface of greater than 700 m²/g.

3. The activated carbon according to claim 2, wherein the specific surface is greater than 1,000 m²/g.

4. The activated carbon according to claim 2, wherein the specific surface is greater than 2,000 m²/g.

5. The activated carbon according to claim 2, wherein the specific surface is greater than 2,500 m²/g.

6. The activated carbon according to claim 1, wherein the activated carbon has a pronounced micropore structure.
